(19) United States
(12) Patent Application Publication
(10) Pub. No.: US 2019/0160901 A1
(43) Pub. Date: May 30, 2019

(54) Kit System For Producing A Roadable Aircraft

(71) Applicant: Allison Aviation Corp., Brookfield, WI (US)

(72) Inventors: Alan T. Doyle, Brookfield, WI (US); Scott H. Micoley, Plymouth, WI (US)

(21) Appl. No.: 16/200,890

(22) Filed: Nov. 27, 2018

Related U.S. Application Data
(60) Provisional application No. 62/590,814, filed on Nov. 27, 2017.

(51) Int. Cl. B60F 5/02; B64C 37/02

(52) U.S. Cl. CPC B60F 5/02; B64C 37/02

(57) ABSTRACT

A roadable aircraft includes an automobile; a retractable wing arrangement secured to the automobile that is movable between an extended flight configuration and a retracted non-flight configuration; an engine and propeller assembly secured to the automobile; and a tail arrangement secured to the automobile that is movable between an extended flight position and a retracted non-flight position. The retractable wing arrangement, the engine and propeller assembly and the tail arrangement comprise components of a kit that may include a frame configured to secure the components of the kit to the automobile. The frame may include an upper frame member to which the engine and propeller assembly is secured, and a pair of side frame members that extend downwardly from opposite ends defined by the upper frame member and that are configured to be engaged with a frame of the automobile.

### CROSS-REFERENCE TO RELATED APPLICATION

This application claims the benefit of U.S. provisional patent application Ser. No. 62/590,814 filed Nov. 27, 2017, the entire disclosures of which are hereby incorporated by reference.

### BACKGROUND AND SUMMARY

This invention relates to aircraft, and more particularly to aircraft that can be converted between a flying configuration and a road configuration.

Numerous advancements have been made in transportation involving aircraft that can be used in flight and also operated on roads, streets and highways, commonly known as roadable aircraft. Universally, however, known roadable aircraft involves an aircraft fuselage with wings and a tail section that can be converted between flight and non-flight configurations, with the fuselage being provided with a suspension and wheels that enable it to be operated on road surfaces. While aircraft of this type may be functional, a significant drawback to commercialization and acceptance of such aircraft is cost resulting from highly specialized, complicated components and low production volumes.

It is an object of the present invention to provide a roadable aircraft that is relatively simple in its components, construction and operation, and which takes advantage of relatively low production costs for a significant portion of the aircraft.

In accordance with one aspect of the invention, a roadable aircraft includes an automobile including an interior passenger area; a retractable wing arrangement secured to the automobile, wherein the retractable wing arrangement is movable between an extended flight configuration and a retracted non-flight configuration; an engine and propeller assembly secured to the automobile; and a tail arrangement secured to the automobile, wherein the tail arrangement is movable between an extended flight position and a retracted non-flight position.

Representatively, the retractable wing arrangement, the engine and propeller assembly and the tail arrangement comprise components of a kit that may include a frame configured to secure the components of the kit to the automobile. The frame may include an upper frame member to which the engine and propeller assembly is secured, and a pair of side frame members that extend downwardly from opposite ends defined by the upper frame member and that are configured to be engaged with a frame of the automobile. The tail arrangement is secured to the frame and is movable relative to the frame between the extended flight position and the retracted non-flight position.

The retractable wing arrangement may be in the form of a left wing section and a right wing section. In the extended flight configuration the left and right wing sections extend outwardly from left and right sides, respectively, of the automobile and in the retracted non-flight configuration the left and right wing sections are positioned one on top of the other above the automobile and in alignment with a longitudinal axis defined by the automobile.

In accordance with another aspect of the invention, a kit system for converting an automobile for flight includes a frame; an engine and propeller assembly carried by the frame; a retractable wing arrangement carried by the frame, wherein the retractable wing arrangement is movable between an extended flight configuration and a retracted non-flight configuration; and a tail carried by the frame, wherein the tail arrangement is movable between an extended flight position and a retracted non-flight position. The frame is configured and arranged to be secured to the automobile, and the engine and propeller assembly, the retractable wing arrangement and the tail function to provide flight for the automobile when the retractable wing arrangement and the tail are in the extended flight configuration and function to allow road operation of the automobile when the retractable wing arrangement and the tail are in the retracted non-flight configuration.

The frame may include an upper frame member to which the engine and propeller assembly is secured, and a pair of side frame members that extend downwardly from opposite ends defined by the upper frame member and that are configured to be engaged with a frame of the automobile. The retractable wing arrangement may include a left wing section and a right wing section. In the extended flight configuration the left and right wing sections extend outwardly from left and right sides, respectively, of the frame and in the retracted non-flight configuration the left and right wing sections are positioned one on top of the other.

In accordance with yet another aspect of the invention, a method of converting an automobile for flight includes the acts of providing an automobile including an interior passenger area; securing a retractable wing arrangement to the automobile, wherein the retractable wing arrangement is movable between an extended flight configuration and a retracted non-flight configuration; securing an engine and propeller assembly to the automobile; and securing a tail arrangement to the automobile, wherein the tail arrangement is movable between an extended flight position and a retracted non-flight position. Representatively, the retractable wing arrangement, the engine and propeller assembly and the tail arrangement comprise components of a kit, and the kit may include a frame to which the retractable wing arrangement, the engine and propeller assembly and the tail arrangement are secured. The acts of securing the retractable wing arrangement, the engine and propeller assembly and the tail arrangement to the automobile are carried out by securing the frame to the automobile.

Other aspects, features and advantages of the invention will become apparent to those skilled in the art from the following detailed description and accompanying drawings. It should be understood, however, that the detailed description and specific examples, while indicating certain embodiments of the present invention, are given by way of illustration and not of limitation. Many changes and modifications may be made within the scope of the present invention without departing from the spirit thereof, and invention includes all such modifications.

### BRIEF DESCRIPTION OF THE DRAWINGS

A clear conception of the advantages and features constituting the present invention, and the construction and operation of typical mechanisms provided with the present invention, will become more readily apparent by referring to be exemplary, and therefore non-limiting, embodiment illustrated in the drawings accompanying and forming a part of this specification, wherein like reference numerals designate the same elements can be several views, and in which:

FIG. 1 is an isometric view of a roadable aircraft produced using a vehicle and the kit system in accordance with the present invention, showing the wing sections and tail section of the kit system in a deployed, flight configuration;

FIG. 2 is a side elevation view of the roadable aircraft of FIG. 1;

FIG. 3 is a front elevation view of the roadable aircraft of FIGS. 1 and 2;

FIG. 4 is a top plan view of the roadable aircraft of FIGS. 1-3;

FIG. 5 is an isometric view illustrating a vehicle and the components of the kit system of FIGS. 1-4 in a disassembled configuration;

FIG. 6 is a partial isometric view illustrating a portion of the kit system of FIGS. 1-5, showing movement of the wing sections to a forward position in advance of movement of the wing sections to the non-flight configuration;

FIG. 7 is a partial side elevation view of the kit system of FIGS. 1-6 showing a first step in moving the wing sections toward the non-flight configuration;

FIG. 8 is a partial elevation view of the wing sections of the kit system of FIGS. 1-7 in movement of the wing sections toward the non-flight configuration;

FIG. 9 is a partial side elevation view similar to FIG. 8 in the opposite direction of the side elevation view as shown in FIG. 8;

FIG. 10 is a partial isometric view showing components of a mechanism employed to move the wing sections in the kit system of FIGS. 1-9 between the flight configuration and the non-flight configuration;

FIG. 11 is a partial isometric view of the kit system of FIGS. 1-10 showing movement of one of the wing sections to an intermediate position between the flight configuration and the non-flight configuration;

FIG. 12 is a view similar to FIG. 11 showing movement of the other of the wing sections to an intermediate position between the flight configuration and the non-flight configuration;

FIG. 13 is a side elevation view of the vehicle and kit system with the wing sections in the intermediate position between the flight configuration and the non-flight configuration as shown in FIG. 12 and the tail section in the extended position; and

FIG. 14 is a view similar to FIG. 13 showing the wing sections in a retracted, non-flight configuration and the tail section in the retracted position.

In describing the embodiment of the invention which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the words “connected,” “attached,” or terms similar thereto are often used. They are not limited to direct connection or attachment, but include connection or attachment to other elements where such connection or attachment is recognized as being equivalent by those skilled in the art.

### DETAILED DESCRIPTION

The various features and advantageous details of the subject matter disclosed herein are explained more fully with reference to the non-limiting embodiment described in detail in the following description.

Generally, the invention involves adding components to a conventional vehicle, such as an automobile, that has been modified and structurally reinforced, so that the modified and reinforced automobile functions essentially as the fuselage of the aircraft.

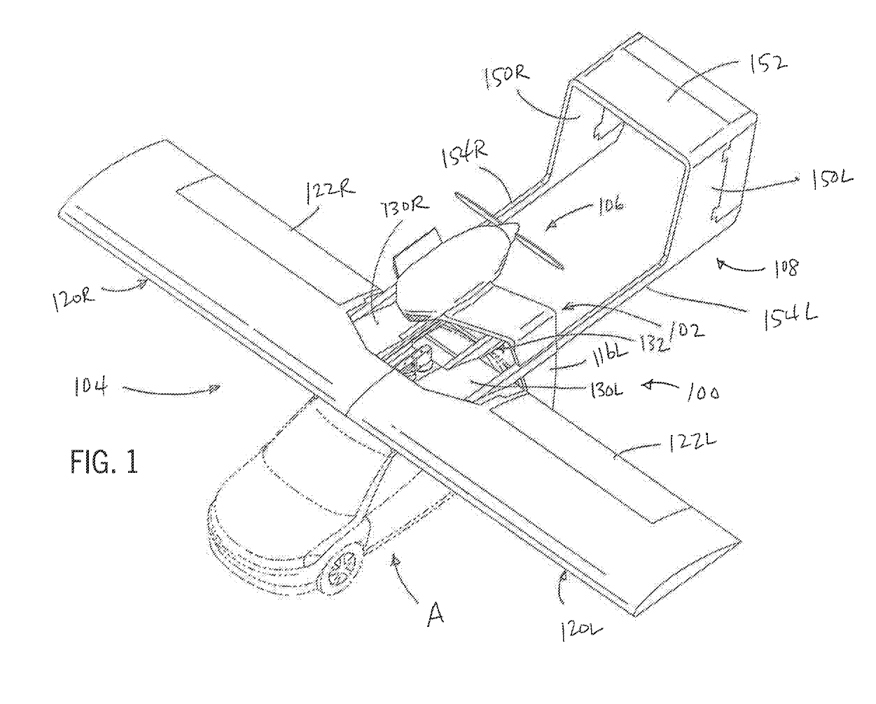

FIG. 1 illustrates a kit system in accordance with the present invention, shown generally at 100, for use in producing a roadable aircraft, i.e. a craft that can be used both for flying and for operation on conventional roadways. The kit system 100 generally includes a frame 102, a retractable wing assembly 104, an engine and propeller assembly 106, and a retractable tail assembly 108.

In a manner to be explained, the kit system 100 is adapted to be mounted to a conventional automobile A that has been modified and structurally reinforced, so that the automobile A is used in a conventional manner during operation on a roadway and then essentially functions as the fuselage of the aircraft during flight. The automobile A may be any satisfactory factory-produced make and model of automobile as desired. Representatively, the automobile A may be a compact of mid-size two- or four-door coupe-type or sedan-type automobile having the capacity to seat 4 to 5 persons. The automobile A defines an interior compartment with a driver/pilot seat and seating for additional passengers, as is known.

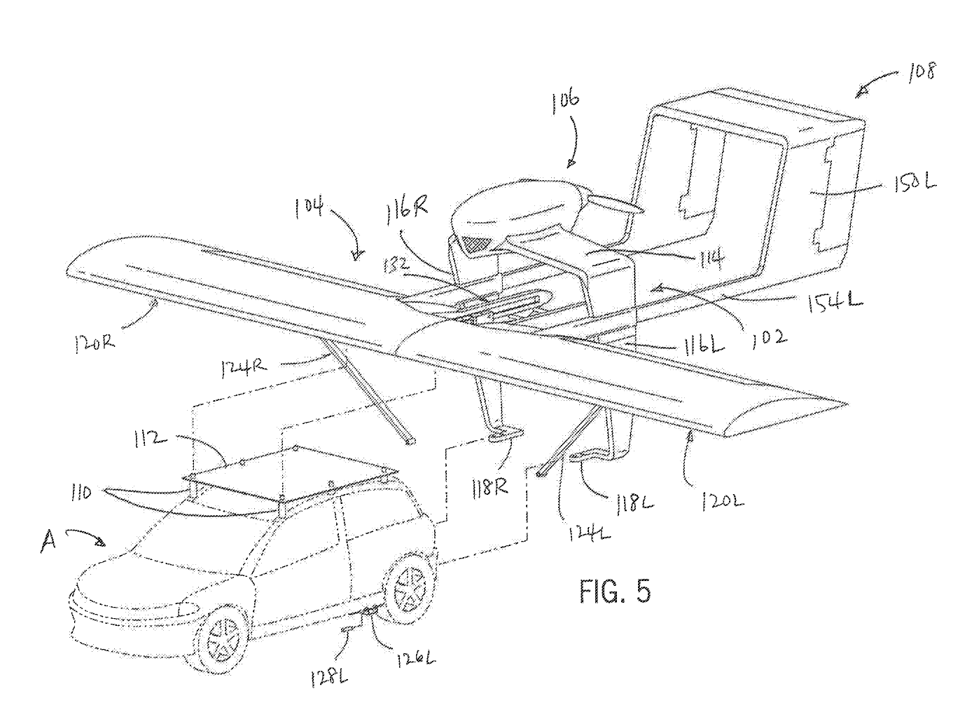

Various adaptations and modifications are made to automobile A that enable it to be used as the body or fuselage of the aircraft. Specifically, with reference to FIG. 5, such adaptations and modifications include a series of reinforcing and support posts 110 that are secured to the structural frame of the automobile A. In the illustrated embodiment, six (6) support posts 110 are secured to the frame of the automobile A: two support posts 110 are secured to the automobile frame and extend upwardly from the front area of the automobile A, two support posts 110 are secured to the automobile frame and extend upwardly from the intermediate area of the automobile A, and two support posts 110 are secured to the automobile frame and extend upwardly from the rear area of the automobile A. It is understood, however, that any desired number supports may be employed and that the supports may be secured to the automobile A in any satisfactory location, also as desired.

The support posts 110 are employed to secure the components of the kit system 100 to the automobile A. In a representative embodiment as shown in the drawings, a platform 112 is secured to the support posts 110 above the top of the automobile A, and the frame 102 of the kit system 100 is secured to the platform 112.

The frame 102 of the kit system 110 includes an upper cross-member 114 to which the engine and propeller assembly 104 is mounted, in combination with a pair of side frame members 114L, 114R that are secured to and extend downwardly from the left and right ends, respectively, of cross-member 112. Side frame members 114L, 114R terminate in mounting feet 116L, 116R, respectively, which are adapted to be secured to a rear area of the frame of the automobile A.

In the illustrated embodiment, the upper cross-member 114 of frame 102 is shown as a pair of frame members, each of which is interconnected at its inner end with the housing of engine and propeller assembly 106. It is understood, however, that the upper cross-member of frame 102 may also be in the form of a one-piece member that extends between the side frame members 116L, 116R, with the engine and propeller assembly 106 being separate from and mounted to, either above or below, the one-piece upper frame cross-member.

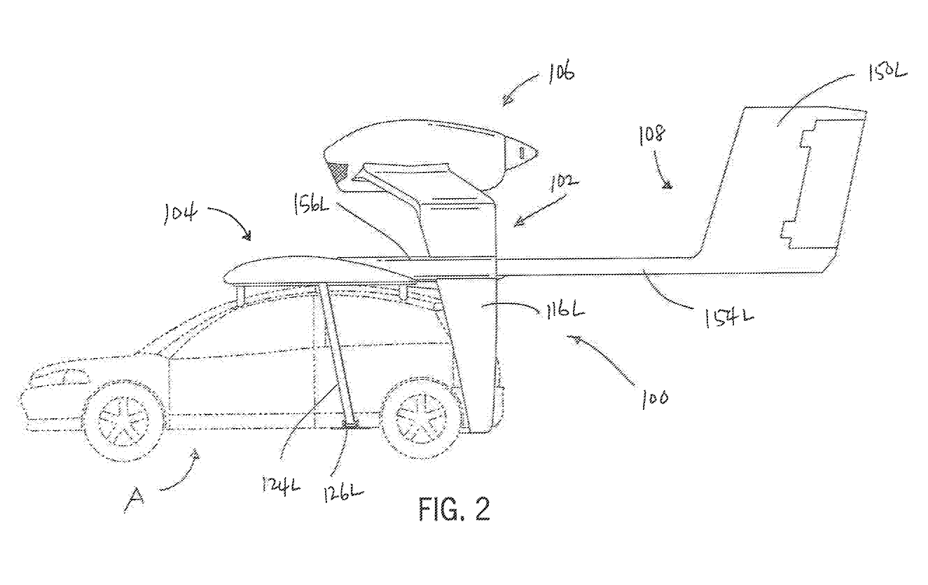

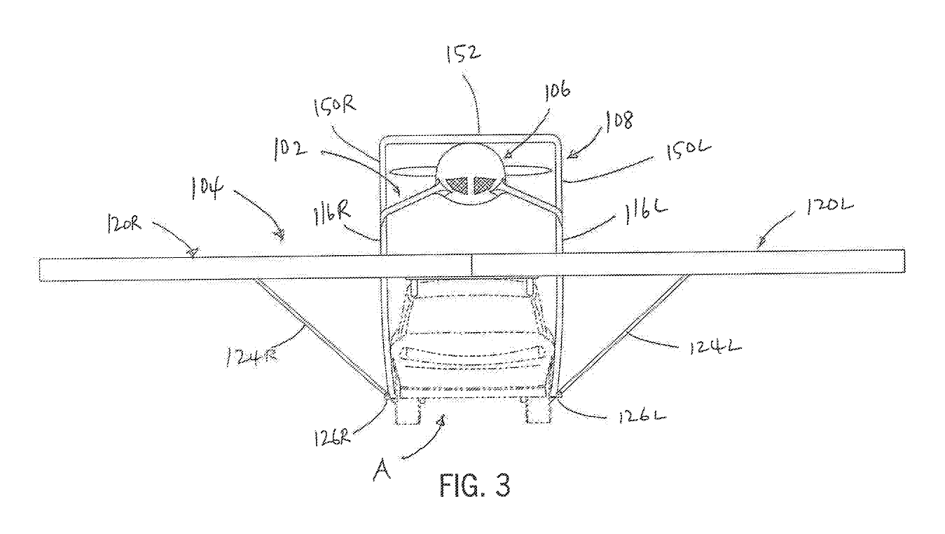

The wing assembly 104 includes a left wing member 120L and a right wing member 120R. In a manner as is known, respective left and right wing members 120L, 120R include respective ailerons 122L, 122R. In addition, as shown in FIGS. 2 and 3, respective left and right wing members 120L, 120R are provided with respective struts 124L, 124R. Each strut 124L, 124R is pivotably mounted at its upper end to the underside of its respective wing section 120L, 120R so that it can be moved between a raised, inoperative position in which it is secured to and stowed on or in the underside of its respective wing section 120L, 120R, and a lowered, operative position as shown in FIGS. 2, 3 and 5. When the struts 124L, 124R are in the lowered, operative position, the lower end of each strut 124L, 124R is releasably secured to a respective mounting plate 126L, 126R secured to and extending laterally outwardly from the frame of the automobile A. Representatively, the lower end of each strut 124L, 124R may be secured in position via a pin such as shown at 128L (FIG. 5).

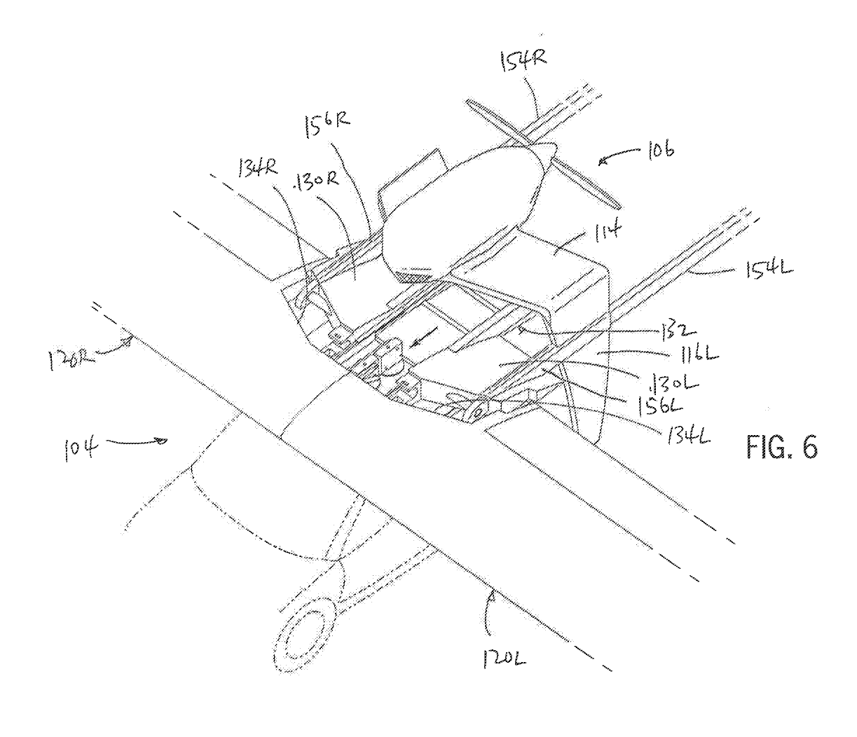

As shown in FIGS. 1 and 6, a pair of stationary wing sections 130L, 130R are mounted to a subframe 132 above the platform 112. Wing members 120L, 120R include respective recessed areas 134L, 134R within which respective stationary wing sections 130L, 130R and portions of subframe 132 are received when the wing assembly 104 is in the flight configuration as shown in FIG. 1.

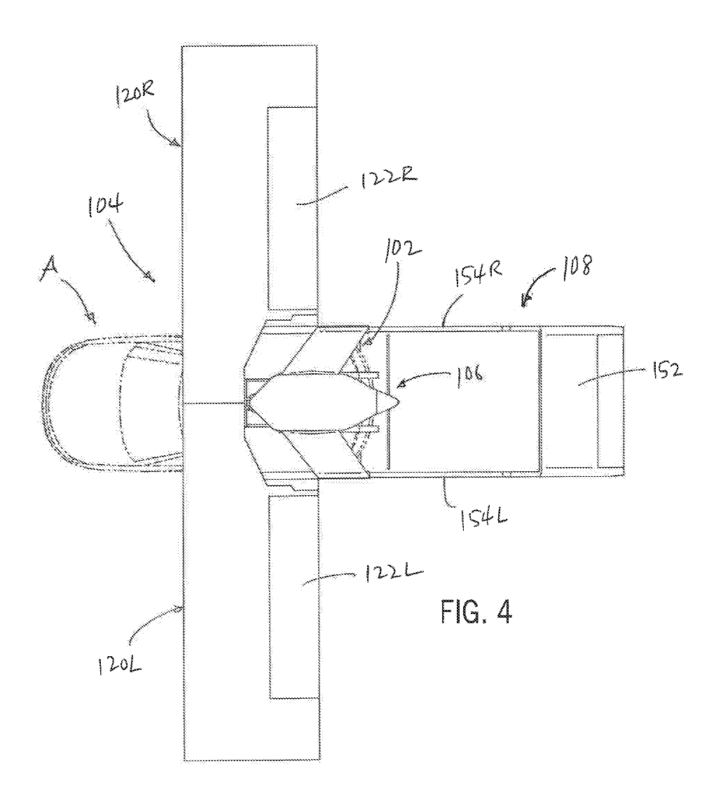

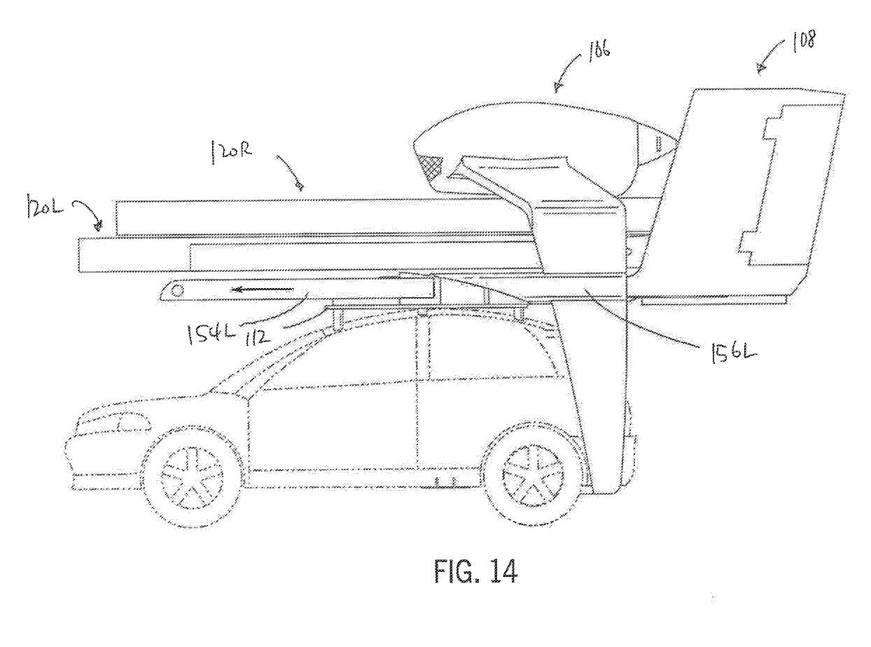

When it is desired to move the wing assembly 104 from the flight configuration as shown in FIGS. 1-5 to the non-flight configuration as shown in FIG. 14, the wing assembly 104 is first moved forwardly to a first intermediate position as shown in FIG. 6. Representatively, wing assembly 104 may be mounted to the subframe 132 for front-rear movement in response to operation of a suitable actuator, such as, but not limited to, a hydraulic cylinder assembly or an electrically operated linear actuator. Such forward movement of wing assembly 104 causes separation of wing assembly 104 from the stationary wing sections 130L, 130R at the recessed areas 134L, 134R.

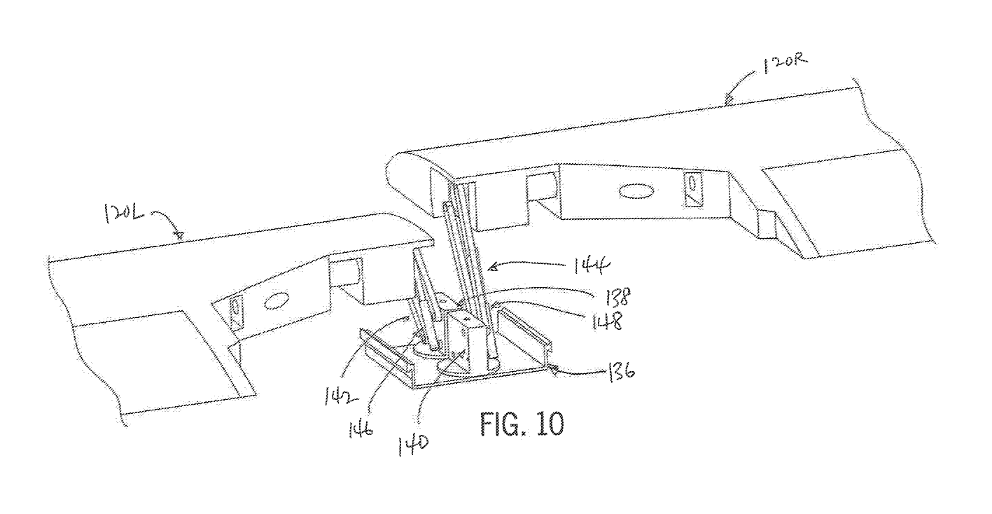

As shown in FIG. 10, the wing members 120L, 120R of assembly 104 may be secured at their inner ends to a carrier 136, which is slidably mounted to the subframe 132 for providing the above-described front-rear movement of wing assembly 104 relative to subframe 132. A front turret 138 and a rear turret 140 are mounted to the carrier 136. A front linkage 142 is connected between front turret 140 and the inner end of wing member 120L, and likewise a rear linkage 144 is connected between rear turret 140 and the inner end of wing member 120R. Suitable extendable and retractable actuators 146, 148, such as, but not limited to, hydraulic cylinder assemblies or electrically operated linear actuators, are connected between front and rear turrets 138, 140, respectively, and the respective inner ends of wing members 120L, 120R. In addition, suitable actuators (not shown) are interconnected with front and rear turrets 138, 140, respectively, for providing selective rotatable movement of turrets 138, 140 relative to carrier 136.

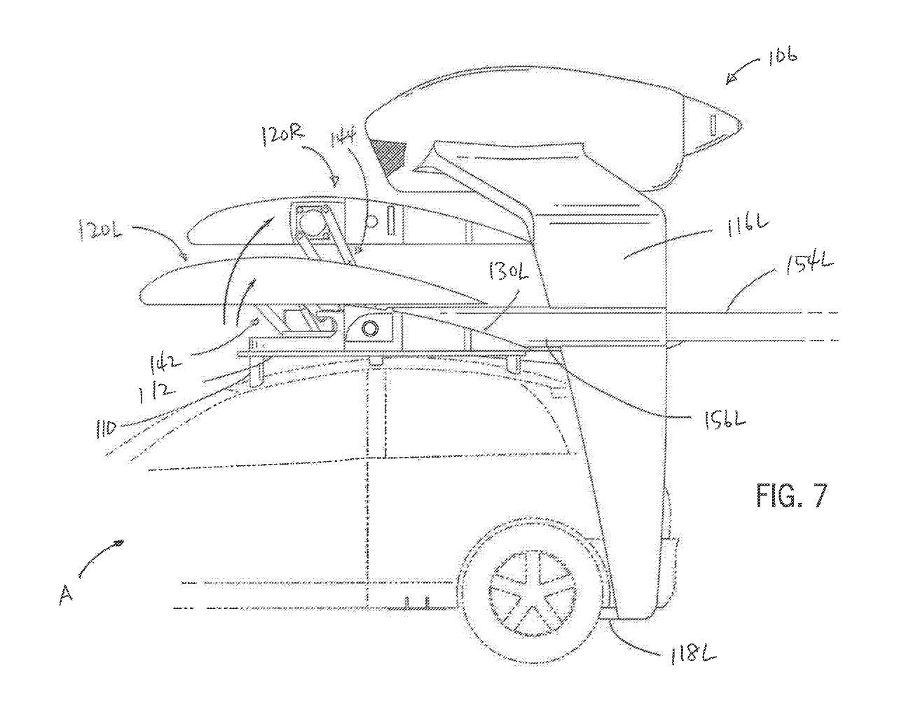

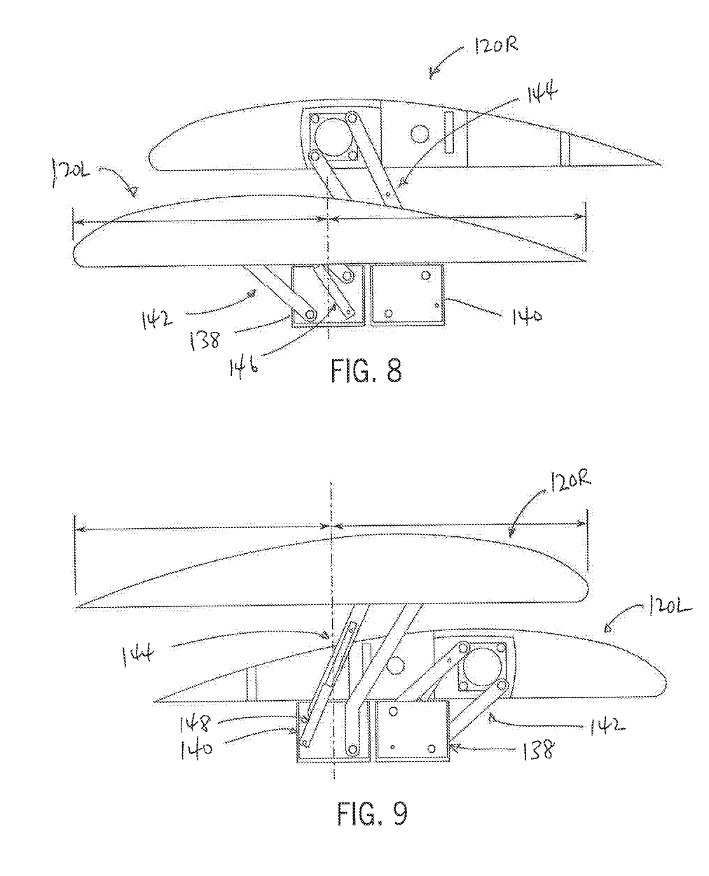

Once wing assembly 104 has been moved forwardly to the first intermediate position as shown in FIG. 6, movement of wing assembly 104 toward the non-flight configuration continues by elevating the wing members 120L, 120R as shown in FIGS. 7-10. To accomplish this, actuators 146, 148 are operated to raise the inner ends of wing members 120L, 120R, respectively. When actuator 146 is operated to elevate the inner end of wing member 120L, linkage 142 causes upward and rearward movement of the inner end of wing member 120L to a first elevation relative to carrier 136. Similarly, when actuator 148 is operated to elevate the inner end of wing member 120R, linkage 144 causes upward and rearward movement of the inner end of wing member 120R to a second elevation relative to carrier 136. Linkages 142, 144 are configured such that, when wing members 120L, 120R are elevated relative to carrier 136, the first elevation of the inner end of wing member 120L is below the second elevation of the inner end of wing member 120R. The differential in the elevated positions of the inner ends of wing members 120L, 120R is such that the lower surface of wing member 120R is positioned above the upper surface of wing member 120L.

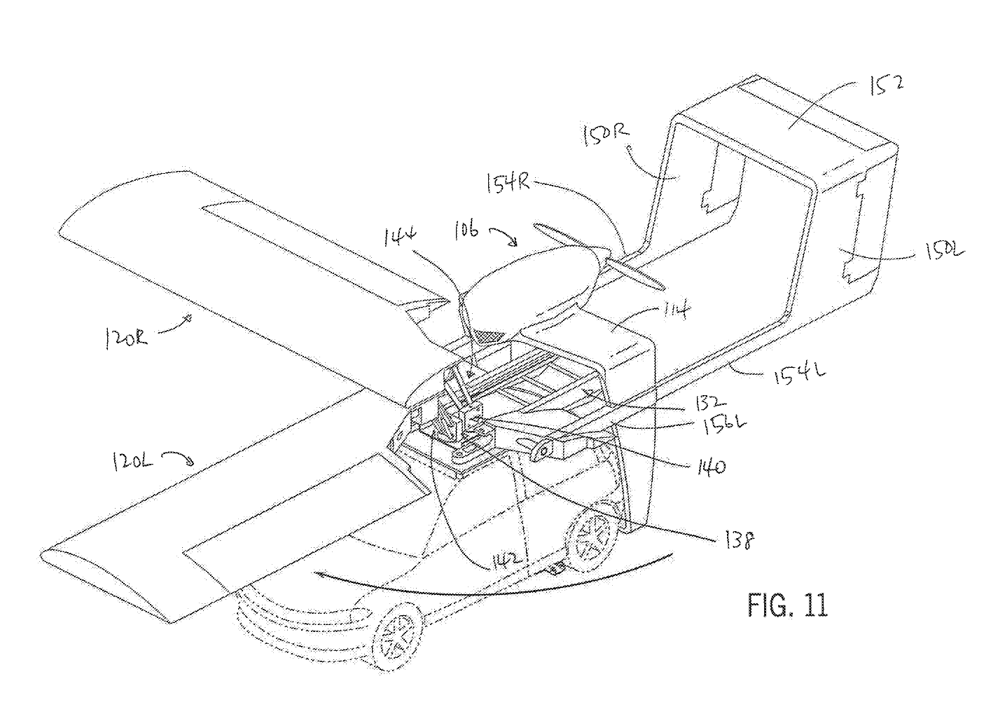

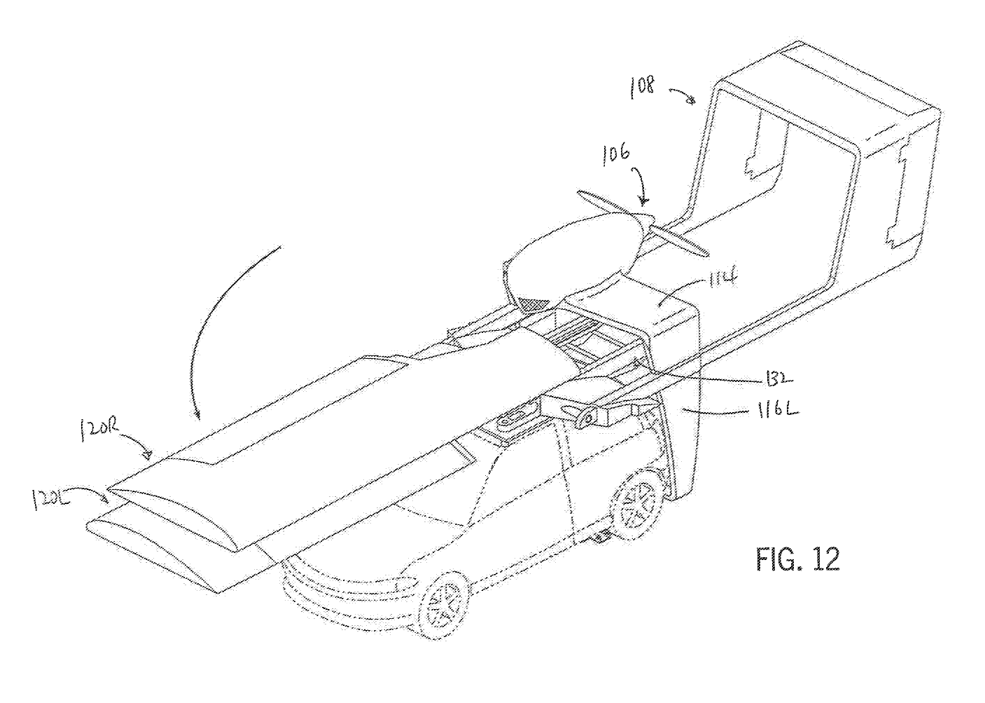

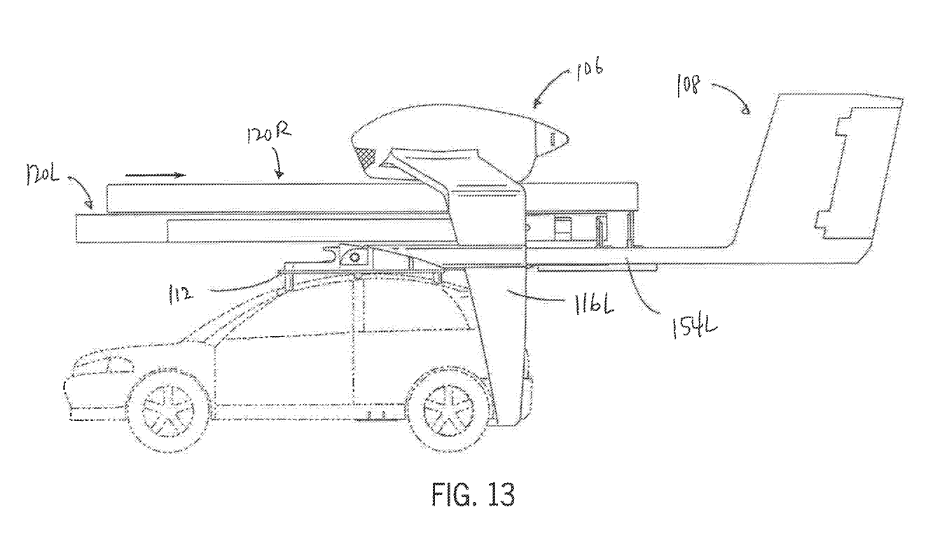

After wing members 120L, 120R are moved to their elevated positions as described, front and rear turrets 138, 140, respectively, are operated to rotate the respective wing members 120L, 120R to second intermediate positions. As shown in FIG. 11, front turret 138 is first operated to rotate wing member 120L to place wing member 120L in alignment with the longitudinal axis of automobile A. In the illustrated embodiment, the front turret 138 rotates wing member 120L roughly 90°. Similarly, as shown in FIG. 12, rear turret 140 is then operated to rotate wing member 120R to place wing member 120R in alignment with the longitudinal axis of automobile A. Again, in the illustrated embodiment, the front turret 140 rotates wing member 120R roughly 90°. The differential in the elevated positions of wing members 120L and 120R is such that wing member 120R overlies wing member 120L when the wing members 120L, 120R are rotated to their second intermediate positions. Referring to FIGS. 13 and 14, the wing members 120L, 120R are then moved rearwardly between the side members 116L, 116R of the frame 102 to a stowed, non-flight configuration, by rearward movement of carrier 136 on subframe 132.

The tail assembly 108, or empennage, includes vertical stabilizers 150L, 150R and a horizontal stabilizer, which are connected together to form an inverted U-shaped configuration. It is understood, however, that a tail assembly having any other satisfactory configuration as desired may be employed. The tail assembly 108 is secured to an extension and retraction mechanism, which in the illustrated embodiment includes a pair of extendible and retractable rails 154L, 154R. The rails 154L, 154R may, for example, have a telescoping configuration, wherein the rails 154L, 154R are slidably received within respective support tubes 156L, 156R that are secured to respective frame side members 116L, 116R. Suitable actuators, such as linear actuators or fluid-operated cylinders, may be employed for extending and retracting the rails 154L, 154R. Extension of the rails 154L, 154R functions to place tail assembly 108 in an operative position for flight, as shown in FIGS. 1-13, and retraction of the rails 154L, 154R functions to place tail assembly 108 in a retracted, non-flight configuration, as shown in FIG. 14, for on-road operation of aircraft 18.

Representatively, the frame 102, wing assembly 104, engine and propeller assembly 106 and tail assembly 108 are sold in kit form together with the required structural components for modification of automobile A. That is, a user will purchase automobile A and have it modified and reinforced as set forth above, and the wing assembly 104, engine and propeller assembly 106 and tail assembly 108 are then secured by the user or installer to the modified and reinforced automobile A.

In use, once the frame 102, wing assembly 104, engine and propeller assembly 106 and tail assembly 108 are installed on the automobile A, the wing assembly 104 can be placed in the non-flight configuration and the tail assembly 108 retracted so as to allow the automobile A to be operated on roads and streets. This is accomplished by the normal, factory-installed engine and drivetrain of the automobile A without operation of engine and propeller assembly 106. When it is desired to convert to a flight configuration, the wing assembly 104 is placed in the flight configuration by reversing the above-described steps, and the tail assembly 108 extended. The engine and propeller assembly 106 is then operated for flight.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It is also understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

1. An aircraft, comprising:
an automobile including an interior passenger area; and
a retractable wing arrangement secured to the automobile, wherein the retractable wing arrangement is movable between an extended flight configuration and a retracted non-flight configuration;
an engine and propeller assembly secured to the automobile; and
a tail arrangement secured to the automobile, wherein the tail arrangement is movable between an extended flight position and a retracted non-flight position.

2. The aircraft of claim 1, wherein the retractable wing arrangement, the engine and propeller assembly and the tail arrangement comprise components of a kit.

3. The aircraft of claim 2, wherein the kit further includes a frame configured to secure the components of the kit to the automobile.

4. The aircraft of claim 3, wherein the frame includes an upper frame member to which the engine and propeller assembly is secured, and a pair of side frame members that extend downwardly from opposite ends defined by the upper frame member and that are configured to be engaged with a frame of the automobile.

5. The aircraft of claim 4, wherein the tail arrangement is secured to the frame and is movable relative to the frame between the extended flight position and the retracted non-flight position.

6. The aircraft of claim 3, wherein the retractable wing arrangement comprises a left wing section and a right wing section, wherein in the extended flight configuration the left and right wing sections extend outwardly from left and right sides, respectively, of the automobile and wherein in the retracted non-flight configuration the left and right wing sections are positioned one on top of the other above the automobile and in alignment with a longitudinal axis defined by the automobile.

7. The aircraft of claim 6, wherein an inner end defined by the left wing section is secured to a first rotatable turret via a first linkage, and wherein an inner end defined by the right wing section is secured to a second rotatable turret via a second linkage, wherein the first and second turrets are operable to rotate the left and right wing sections, respectively, between the extended flight configuration and the retracted non-flight configuration, and wherein the first and second linkages are configured to position the left and right wing sections one on top of the other when the left and right wing sections are in the retracted non-flight configuration.

8. A kit system for converting an automobile for flight, comprising:
a frame;
an engine and propeller assembly carried by the frame;
a retractable wing arrangement carried by the frame, wherein the retractable wing arrangement is movable between an extended flight configuration and a retracted non-flight configuration; and
a tail carried by the frame, wherein the tail arrangement is movable between an extended flight position and a retracted non-flight position;
wherein the frame is configured and arranged to be secured to the automobile and wherein the engine and propeller assembly, the retractable wing arrangement and the tail function to provide flight for the automobile when the retractable wing arrangement and the tail are in the extended flight configuration and function to allow road operation of the automobile when the retractable wing arrangement and the tail are in the retracted non-flight configuration.

9. The kit system of claim 8, wherein the frame includes an upper frame member to which the engine and propeller assembly is secured, and a pair of side frame members that extend downwardly from opposite ends defined by the upper frame member and that are configured to be engaged with a frame of the automobile.

10. The kit system of claim 9, wherein the retractable wing arrangement comprises a left wing section and a right wing section, wherein in the extended flight configuration the left and right wing sections extend outwardly from left and right sides, respectively, of the frame and wherein in the retracted non-flight configuration the left and right wing sections are positioned one on top of the other.

11. The kit system of claim 10, wherein an inner end defined by the left wing section is secured to a first rotatable turret via a first linkage, and wherein the right wing section is secured to a second rotatable turret via a second linkage, wherein the first and second turrets are operable to rotate the left and right wing sections, respectively, between the extended flight configuration and the retracted non-flight configuration, and wherein the first and second linkages are configured to position the left and right wing sections one on top of the other when the left and right wing sections are in the retracted non-flight configuration.

12. A method of converting an automobile for flight, comprising the acts of:
providing an automobile including an interior passenger area;
securing a retractable wing arrangement to the automobile, wherein the retractable wing arrangement is movable between an extended flight configuration and a retracted non-flight configuration;
securing an engine and propeller assembly to the automobile; and
securing a tail arrangement to the automobile, wherein the tail arrangement is movable between an extended flight position and a retracted non-flight position.

13. The method of claim 12, wherein the retractable wing arrangement, the engine and propeller assembly and the tail arrangement comprise components of a kit.

14. The method of claim 13, wherein the kit further includes a frame to which the retractable wing arrangement, the engine and propeller assembly and the tail arrangement are secured, and wherein the acts of securing the retractable wing arrangement, the engine and propeller assembly and the tail arrangement to the automobile are carried out by securing the frame to the automobile.

15. The method of claim 14, wherein the frame includes an upper frame member to which the engine and propeller assembly is secured, and a pair of side frame members that extend downwardly from opposite ends defined by the upper frame member, and further comprising the act of securing the side frame members with a frame of the automobile.

16. The method of claim 14, wherein the tail arrangement is secured to the frame and is movable relative to the frame between the extended flight position and the retracted non-flight position.

17. The method of claim 14, wherein the retractable wing arrangement comprises a left wing section and a right wing section, wherein in the extended flight configuration the left and right wing sections extend outwardly from left and right sides, respectively, of the automobile and wherein in the retracted non-flight configuration the left and right wing sections are positioned one on top of the other above the automobile and in alignment with a longitudinal axis defined by the automobile.

18. The method of claim 17, wherein an inner end defined by the left wing section is secured to a first rotatable turret via a first linkage, and wherein an inner end defined by the right wing section is secured to a second rotatable turret via a second linkage, wherein the first and second turrets are operable to rotate the left and right wing sections, respectively, between the extended flight configuration and the retracted non-flight configuration, and wherein the first and second linkages are configured to position the left and right wing sections one on top of the other when the left and right wing sections are in the retracted non-flight configuration.
